(19) United States
(12) Patent Application Publication
(10) Pub. No.: US 2005/0063774 A1
(43) Pub. Date: Mar. 24, 2005

(54) Attachment device for a load-bearing member

(76) Inventors: Ronald W. Fechter, Belvue, KS (US); John D. Tate JR., Wamego, KS (US); Andrew L. Vering, Manhattan, KS (US)

Correspondence Address: CATERPILLAR INC.;100 N.E. ADAMS STREET, PATENT DEPT., PEORIA, IL, 616296490, US

(21) Appl. No.: 10/665,789

(22) Filed: Sep. 18, 2003

(51) Int. Cl. B25G 3/20

(52) U.S. Cl. 403/374.1

(57) ABSTRACT

The addition of a thumb to a bucket of a work machine allows more uses for the work machine than having only the bucket. Having an attachment device locatable along the length of the stick permits different thumbs and different implement-positioning devices to be used with different work machines, adding more flexibility of use. The disclosed method and apparatus is for an attachment device for attaching an implement-positioning device to a load-bearing member, comprising a base member, a coupling member for adjustably attaching the base member to the load bearing member, and an attachment means for attaching the implement-positioning device to the coupling member.

### TECHNICAL FIELD

This invention relates generally to an apparatus and method for attaching an implement-positioning device at various positions along a load-bearing member.

### BACKGROUND

Work machines, such as backhoe loaders, excavators, or other similar work machines use counteracting thumbs and buckets to grasp, hold, and lift odd-shaped articles such as pipes, structural components, and the like, similar to the thumb of a human hand. When used to perform this secondary grasping, holding, or lifting function, a counteracting thumb is normally pivotally attached to a load-bearing member, lift arm assembly, or a bucket to accomplish the grasping, holding, and lifting function. An implement-positioning device, such as a hydraulic cylinder, is used to curl and uncurl the thumb to perform the grasping, holding, and lifting function. The hydraulic cylinder, in turn, is attached to a load-bearing member by means of an attachment device. Having the attachment device adjustably attachable at preselected locations along the load-bearing member permits different thumbs and different implements to be used with different work machines thereby increasing the versatility of the work machine.

One known attachment device design is disclosed in U.S. Pat. No. 6,203,267 B1 that issued to Heiple et. al. on Mar. 20, 2001. It discloses a material handling assembly mountable on a stick of a work machine generally having a thumb pivotally attachable to the stick and cooperable with a bucket. The material handling assembly further includes a bracket mountable on the stick having a guideway therein, a strut received within and displaceable along the guideway, and a device for removably attaching the strut to the bracket at selected points along the length of the guideway. The adjustability of this design is limited. The material handling assembly is not able to increase the distance between the strut and the stick to adjust for different sized struts. And, the material handling assembly is bulky and can limit the rotational ability of the thumb.

The present invention is directed to overcoming one or more of the problems as set forth above.

### SUMMARY OF THE INVENTION

In one aspect of the present invention, an attachment device for attaching an implement-positioning device to a load-bearing member comprises a base member, a coupling member for attaching the base member to the load-bearing member, and an attachment means for attaching the implement-positioning device to the coupling member.

In another aspect of the present invention, a method for using an attachment device for attaching an implement-positioning device, having a cylinder end, to a load-bearing member, the attachment device comprising a base member and a coupling member for attaching the base member to the load-bearing member, comprises the steps of removing the coupling member, positioning the base member to a preselected location along the load-bearing member, and attaching the base member to the preselected location with the coupling member.

### BRIEF DESCRIPTION OF THE DRAWINGS

For a better understanding of the present invention, reference may be made to the accompanying drawings in which:

FIG. 1 is a diagrammatic side view of an attachment device of the present invention adjustably attached to a stick of a work machine;

FIG. 2 is a diagrammatic side view of an alternative embodiment of the attachment device of the present invention adjustably attached to the stick of the work machine; and

FIG. 2a is a diagrammatic side view of an alternate embodiment of the separation device.

### DETAILED DESCRIPTION

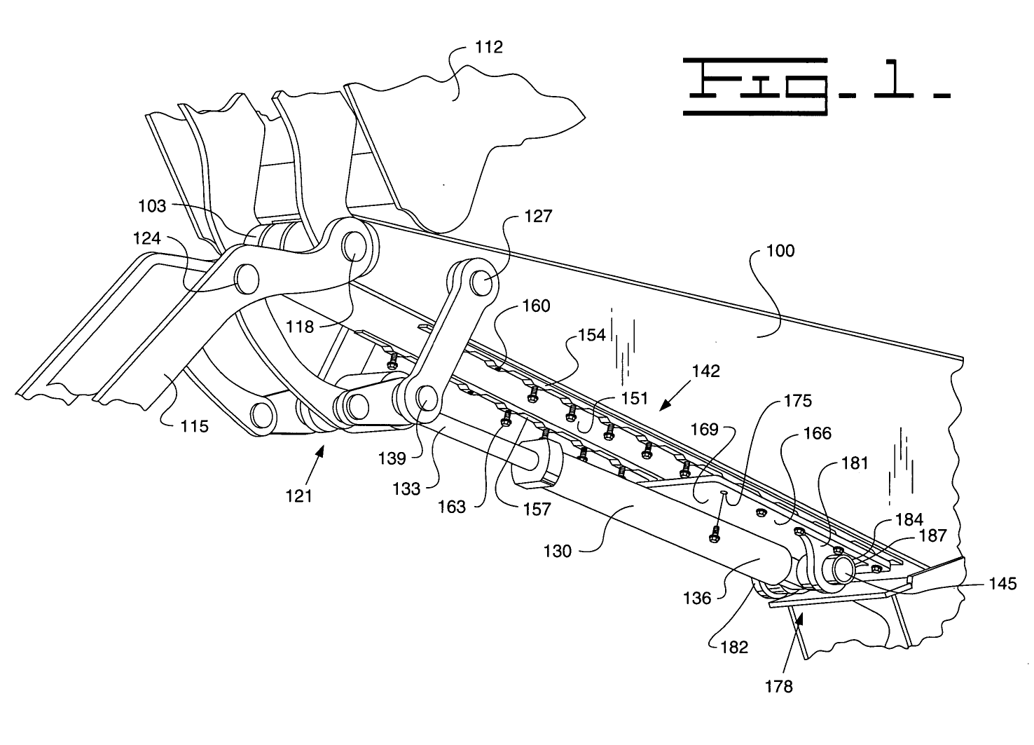

Referring to the drawings, shown in FIG. 1 is a load-bearing member such as a stick 100 of a work machine (not shown) having an end portion 103. A pair of implements comprising, for exemplary purposes herein, a first implement or a bucket 112, and a second implement or a thumb 115, is pivotally attached in proximity to the end portion 103 of the stick 100 by means of a pin 118. A linkage assembly 121 is pivotally attached to the thumb 115 by means of a pin 124 and is pivotally attached to the stick 100 by means of a pin 127. Also shown is an implement-positioning device, such as a hydraulic cylinder 130, having an aperture 131 and a rod end 133 pivotally attached to the linkage assembly 121 by means of a pin 139 such that the hydraulic cylinder 130 is operably attached to the thumb 115 for adjustably controlling the movement of the thumb 115. In addition, the hydraulic cylinder 130 has a cylinder end 136 pivotally attached to an attachment device 142 of the present embodiment by means of a pin 145. Although the implement-positioning device is shown herein as a hydraulic cylinder, the implement-positioning device may comprise other arrangements such as a strut, a tube, a bar, or other device.

Referring further to FIG. 1, the attachment device 142 includes a coupling member such as a plate 151 that extends along the length of the stick 100 and is attached thereto by welding or by another suitable process and a plurality of mechanical fasteners such as bolts 163. The plate 151 includes a first side 154 and a second side 157. The first side 154 and the second side 157 each include a plurality of apertures, denoted as 160, located at preselected locations along the plate 151, and sized to receive the bolts 163.

The attachment device 142 further includes a base member 166 that is adjustably attached to the plate 151 and is locatable at a plurality of preselected locations along the plate 151. The appropriate location of the preselected locations is effected by the size of the stick 100, the size of the hydraulic cylinder 130, the implement or implements used, and on which work machine the attachment device 142 is used, to name some factors. The base member 166 includes a first side 169 and a second side. Only the first side 169 is shown in FIG. 1 as the first side 169 and second side are substantially identical. The first side 169 and second side each include a plurality of apertures, denoted as 175, located such that each respective aperture 175 is substantially aligned with the corresponding aperture 160 of the plate 151 when the base member 166 is attached to the plate 151.

The attachment device 142 further includes an attachment means 178 attached to the base member 166 by welding or by another suitable process onto which the cylinder end 136 of the hydraulic cylinder 130 is pivotally attached. The attachment means 178 includes at least one flange, for exemplary purposes a first flange 181 and a second flange 182 are shown. Each such flange 181, 182 has a flange aperture therein, denoted as 184, and each such flange aperture 184 has a boss, denoted as 187, welded to each side thereof to reinforce the respective apertures 184. The bosses 187 and the flange apertures 184 are sized so as to receive the pin 145. It should be understood, however, that despite a pair of flanges 181, 182 being depicted in FIG. 1, any number of flanges could be used. It should also be understood that a bar, a linkage, a pin, a tube, a bracket, a post, a rod, or other such device could be used instead of the flanges 181, 182 to accomplish the present embodiment.

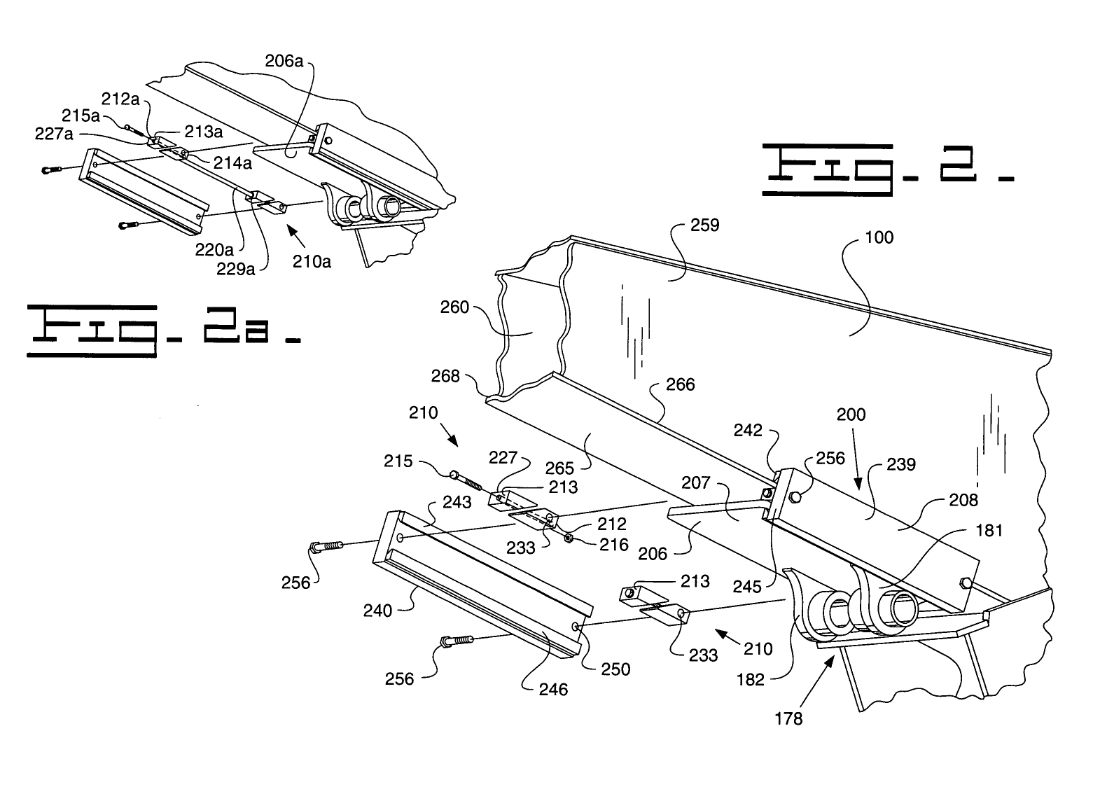

Depicted in FIG. 2 is an alternate embodiment of the attachment device denoted herein as 200. For purposes of clarification, identical components used with the embodiments described herein shall be identified with like numbers. The attachment device 200 of FIG. 2 includes a base member 206 having a top surface 207, a coupling member 208, and at least one separation device 210. The attachment device 200 is infinitely attachable along the stick 100. The base member 206 includes an attachment means 178 substantially illustrated and described previously with respect to the previous embodiment and again used to pivotally attach the hydraulic cylinder 130 to the base member 206.

Referring further to FIG. 2, the at least one separation device 210 of the present embodiment includes a plurality of wedges, denoted as 212, having an end portion 213 and a plurality of mechanical fasteners, such as bolts 215 and nuts 216, each bolt 215 having an end portion 217. The nut 216 is sized so as to engage the end portion 217 of the bolt 215. Further, each wedge 212 is locatable between the base member 206 and the stick 100 for adjusting the distance between the cylinder end 136 of the hydraulic cylinder 130 and the stick 100. For exemplary purposes herein, four wedges 212 and four bots 215 and nuts 216 are shown being utilized with the embodiment described herein. It should be understood, however, that any number of wedges 212 and bolts 215 and nuts 216 could be used to achieve similar results. Additionally, it should be understood that the separation device 210 or any portion thereof, including the wedge 212 that may be set on top of another wedge 212, could be attached to the base member 206.

For the present embodiment described herein, each wedge 212 includes an aperture 227 that is sized such that the aperture 227 is larger than the diameter of the bolt 215 so that the bolt 215 can float up and down in the aperture 227 when it is inserted therein as necessary to set the appropriate thickness of the separation device 210. In order to set the appropriate thickness of the separation device 210 to achieve the desired distance between the base member 206 and the stick 100, two wedges 212 are set on top of each other, the bolt 215 is inserted through the apertures 227 of the wedges 212, and the end portion 217 of the bolt 215 is inserted into the nut 216. The bolt 215 is then threaded at the end portion 213 of the wedge 212 tighter on the nut 216 drawing the bolt 215 through the nut 216 thus drawing the two wedges 212 together so that the combined thickness of the wedges 212 increases as the bolt 215 is tightened on the nut 216. As the wedges 212 are drawn together the bolt 215 is allowed to float in the apertures 227 due to the apertures 227 being oversized, and thus allowing the wedges 212 to move up on each other. Finally, each wedge 212 includes threaded aperture 233, shown in hidden detail. Each such aperture 233 is offset from aperture 227 in the wedges 212 so that the bolts 215 do not intersect aperture 233 when inserted therein.

Alternatively, as depicted in FIG. 2a, the separation device 210a includes a plurality of wedges 212a having a first-end portion 213a and a second-end portion 214a, a plurality of mechanical fasteners such as bolts 215a, and a plurality of bars 220a (one shown), having threaded apertures therein (not shown). The first-end portion 213a of the wedges 212a includes apertures 227a sized to receive the bolt 215a and the second-end portion 214a includes apertures 229a sized to receive the bar 220a. One bar 220a is inserted in the apertures 229a of two wedges 212a so as to connect the wedges 212a together. The bolts 215a are then inserted in the apertures 227a and threaded into the apertures in the bars 220a. In order to set the appropriate thickness of the separation device 210a, the wedges 212a are set on top of each other, the bolts 215a are tightened and the bolts 215a pull the wedges 212a toward the bar 220a and as such draws the wedges 212a together so that the combined thickness of the wedges 212a increases as the bolt 215a is tightened on the bar 220a. This increases the distance between the base member 206a and the stick 100.

Depicted in FIG. 2, the coupling member 208 of the present embodiment comprises a first clamp 239 and a second clamp 240 each of which are used to adjustably attach the base member 206 to the stick 100. It should be understood that although two clamps are shown, any number of clamps could be used to enable the present embodiment. Each clamp 239, 240 includes top portions 242, 243 and bottom portions 245, 246, respectively. Additionally, each clamp 239, 240 includes at least one aperture 250. It should be understood that any number of apertures could be provided in the clamps 239, 240 to achieve similar results. Each aperture 250 is sized to receive a mechanical fastener, such as bolt 256, which is placed through the clamps 239, 240 and is threaded into the apertures 233 of the wedges 212. It should be understood, however, that although bolts are depicted in FIG. 2 as the mechanical fasteners, any suitable means to removably attach the wedges 212 together and/or removably attach the clamps 239, 240 to the wedges 212 could be used.

Finally, the stick 100 includes side plates 259, 260 and a bottom plate 265 having respective side edges 266, 268 each of which extend a predetermined distance beyond the respective side plates 259, 260 of the stick 100. The base member 206 is adjustably attached to the stick by positioning the wedges 212 between the base member 206 and the stick 100 and setting the appropriate thickness thereof so that the top portions 242, 243 of the clamps 239, 240 engage the side edges 266, 268 of the bottom plate 265 and the bottom portions 245, 246 of the clamps 239, 240 engage the top surface 207 of the base member 206 to create the required normal force so as to prevent the base member 206 from slipping from the preselected location along the stick 100. To further prevent the clamps 239, 240 from slipping, the bolts 256 are placed through the apertures 250 in the clamps 239, 240 and threaded into the aperture 233 in the wedges 212.

Industrial Applicability

Work machines, such as excavators and backhoe loaders, are very expensive to purchase. It is, therefore, beneficial for an operator of such work machines to be able to use additional attachments with the work machines to perform additional operations. For example, thumbs are often used in conjunction with buckets to create a gripper, grapple, or the like to lift and carry odd-shaped items such as logs, pipes, and load-bearing components. An implement-positioning device such as a hydraulic cylinder is normally used to curl and uncurl the thumb to perform grasping, holding, and lifting functions. In the present invention, the implement-positioning device, depicted as the hydraulic cylinder 130 is attached to the stick 100 by an attachment device 142, 200. The present invention provides for an attachment device 142, 200 that permits the hydraulic cylinder 130 to be adjustably attached to stick 100 of the work machine so as to adjustably control movement of the thumb 115.

In the first embodiment depicted in FIG. 1, the base member 166 is locatable at preselected locations along the stick 100 thereby allowing for different attachment locations of the hydraulic cylinder 130 to the stick 100. In order to reposition the base member 166, the bolts 163 are loosened and removed; the base member 166 is repositioned to a desired location, and then bolted in place by bolts 163. The hydraulic cylinder 130 is then pivotally attached to the attachment means 178 by concentrically aligning the aperture 131 of the hydraulic cylinder 130 with the aperture 184 of the flanges 181, 182 and inserting the pin 145 therethrough.

To reposition the base member 206 in the alternative embodiment depicted in FIG. 2, the bolts 236 on the clamps 239, 240 are removed and the clamps 239, 240, wedges 212, and the base member 206 are repositioned to the desired location. The top portions 242, 243 of the clamps 239, 240 are positioned on the side edges 266, 268 of the bottom plate 265 and the bottom portions 245, 246 of the clamps 239, 240 are positioned on the top surface 207 of the base member 206. The wedges 212 are positioned between the base member 206 and the stick 100, adjacent the clamps 239, 240. Once the wedges 212 are in position, the appropriate thickness is set by applying pressure to the end portion 213 of the wedge 212 by threading the bolts 215 on the nuts 216 so that end portions 217 of the bolts 215 are drawn through the nuts 216. This will cause the wedges 212 to be drawn together to increase their thickness to create the required normal force so as to prevent the base member 206 from slipping. The bolts 256 are then placed through the apertures 250 in the clamps 239, 240 and are threaded into aperture 233 in the wedges 212 tightening further the attachment device 200 to the stick 100. The hydraulic cylinder 130 is then pivotally attached to the attachment means 178 described previously with respect to the previous embodiment. As should be appreciated by those of ordinary skill in such art, the provision of the clamps 239, 240 and wedges 212 allows for vertical and lateral adjustability of the attachment point of the hydraulic cylinder 130 to the stick 100. This embodiment allows the attachment arrangement 200 to be removed from the stick 100 when needed by removing the bolts 256 and removing the clamps 239, 240, the wedges 212, and the base member 206.

Other aspects, objects and advantages of the invention could be obtained from a study of the drawings, the disclosure and the appended claims.

1. An attachment device for attaching an implement-positioning device to a load-bearing member, comprising:
a base member;
a coupling member for adjustably attaching the base member to the load-bearing member; and
an attachment means for attaching the implement-positioning device to the coupling member.

2. The attachment device of claim 1 wherein the coupling member comprises at least one mechanical fastener.

3. The attachment device of claim 3 wherein the coupling member further comprises at least one aperture sized to receive the mechanical fastener.

4. The attachment device of claim 1 wherein the coupling member comprises at least one clamp adapted to clamp the coupling member with the load-bearing member.

5. The attachment device of claim 4 wherein:
the load-bearing member comprises a bottom plate;
the clamp comprises a top portion to engage the bottom plate; and
the clamp comprises a bottom portion to engage a top surface of the base member.

6. The attachment device of claim 1 wherein the coupling member is attachable to the load-bearing member at a preselected location along the load-bearing member.

7. The attachment device of claim 1 further comprising at least one separation device positionable between the load-bearing member and the base member.

8. The attachment device of claim 7 wherein the at least one separation device comprises a thickness adjustment device for adjusting a thickness of the at least one separation device.

9. The attachment device of claim 8 wherein the thickness adjustment device comprises:
a plurality of wedges each having an aperture;
a mechanical fastener, having an end portion and having a diameter smaller than each aperture; and
a nut sized to engage the end portion.

10. The attachment device of claim 1 wherein the attachment means comprises:
at least one flange having a flange aperture adapted to be substantially concentrically aligned with an implement-positioning device aperture; and
a pin sized for placement within the flange aperture and the implement-positioning device aperture.

11. A method for using an attachment device for adjustably attaching an implement-positioning device, having a cylinder end, to a load-bearing member, the attachment device comprising a base member and a coupling member for removably attaching the base member to the load-bearing member, comprising:
unfastening the coupling member;
positioning the base member to a preselected location along the load-bearing member; and
removably attaching the base member to the preselected location with the coupling member.

12. The method of claim 11 wherein the coupling member comprises at least one mechanical fastener.

13. The method of claim 11 wherein the coupling member comprises at least one clamp.

14. The method of claim 13 further comprising adjusting the distance between the cylinder end of the implement-positioning device and the load-bearing member.

15. The method of claim 14 wherein adjusting the distance between the cylinder end of the implement-positioning device and the load-bearing member comprises providing an at least one separation device, having an end portion, between the base member and the load-bearing member.

16. The method of claim 15 further comprising adjusting the thickness of the at least one separation device.

17. The method of claim 16 wherein adjusting the thickness of the at least one separation device comprises applying pressure to the end portion of the at least one separation device.

18. The method of claim 17 wherein applying the pressure to the end portion of the at least one separation device is by use of a mechanical fastener.

19. A work machine, comprising a load-bearing member having an implement-positioning device infinitely attachable along a length of the load-bearing member.

20. The work machine of claim 19, further comprising:
a first implement and a second implement;
wherein the implement-positioning device is operably attached to the second implement for adjustably controlling the movement of the second implement.
